(19) United States
(12) Patent Application Publication
(10) Pub. No.: US 2013/0089173 A1
(43) Pub. Date: Apr. 11, 2013

(54) SECURING DEVICE FOR A CONTROL ROD IN A NUCLEAR FACILITY

(71) Applicant: AREVA NP GMBH, Erlangen (DE)

(72) Inventors: BENEDIKTUS WINTERMANN, BUCKENHOF (DE); ALFRED GERSTENHOEFER, NUERNBERG (DE); PATRICK KOEHLER, NUERNBERG (DE)

(73) Assignee: AREVA NP GMBH, ERLANGEN (DE)

(21) Appl. No.: 13/649,459

(22) Filed: Oct. 11, 2012

(30) Foreign Application Priority Data
Oct. 11, 2011 (DE) 10 2011 115 513.2

(51) Int. Cl. G21C 7/12

(52) U.S. Cl. CPC G21C 7/12
USPC 376/235

(57) ABSTRACT

A securing device for a control rod in a nuclear facility contains a control rod drive and a drive housing enclosing the control rod drive and configured to pass through a reactor pressure wall. The securing device further has a reactor pressure wall connection piece arranged inwardly of the reactor pressure wall and connected to the reactor pressure wall. A device of this type is to be producible as cost-effectively as possible, is to perform its intended tasks reliably and is to be maintenance-free during operation. Accordingly, a number of connection elements are provided for this purpose between the reactor pressure wall connection piece and the drive housing. A respective connection element forms a form-locking connection to the drive housing and a form-locking connection to the reactor pressure wall connection piece.

### CROSS-REFERENCE TO RELATED APPLICATION

This application claims the priority, under 35 U.S.C. §119, of German application DE 10 2011 115 513.2, filed Oct. 11, 2011; the prior application is herewith incorporated by reference in its entirety.

### BACKGROUND OF THE INVENTION

### Field of the Invention

The invention relates to a securing device for a control rod in a nuclear facility, in particular in a boiling water reactor.

In a nuclear power facility, for example in a nuclear power plant, linearly displaceable control rods are used to control chain reactions of nuclear fission processes in a reactor, in which particle radiation (in particular neutron radiation) is emitted, by absorption of the radiation. The further such control rods, which are typically arranged bundled together in groups, are slid between the nuclear fuel elements, the greater the proportions of particle radiation further driving the chain reaction that are absorbed, and therefore the chain reaction accordingly proceeds more slowly and is accordingly brought to a stop if the control rods are arranged in a fully inserted position in the reactor core. The status and course of the chain reaction are thus dependent on the respective position of the control rods and are determined thereby. A mechanical securing of the control rods in the respective desired position is therefore relevant for a reliable setting of the operating state. In particular, the positioning in the control rod end position necessary for shutdown of the reactor has to be secured in a guaranteed manner from a safety point of view.

In boiling water reactors, high temperatures and pressures are produced in the reactor circuit, and therefore the control rods have to be secured against uncontrolled lowering in the event of a possible failure of the pressurized encapsulation of the mechanically/hydraulically actuated control rod drive. If the control rods lower in an uncontrolled manner, there is a risk of an inadmissible increase in reactor output, which, in extreme cases (with a simultaneous failure of all further safety systems), could lead to core meltdown. To secure the control rods against unintentional lowering, securing devices in which the drive housing of the control rod drive is held on an external shielding plate, for example by tie rods, are normally installed in boiling water reactors. Securing devices of this type generally contain large components of complex design, which are high-maintenance and cost-intensive, limit the installation space due to their geometric expanse and impair the accessibility of further components within the facility, which is disadvantageous in particular when carrying out maintenance and assembly operations.

In an alternative solution, a securing device for a control rod/control rod drive is proposed that contains a drive housing encompassing the control rod drive. The drive housing is configured to pass through the pressure wall of the reactor pressure vessel, wherein the drive housing is secured in the pressure wall by a number of coupling elements. The coupling element(s) is/are generally formed as a component of a bayonet connection. A securing device of this type is described in published, non-prosecuted German patent application DE 10 2011 008 202.6, filed by AREVA NP GmbH on 11 Jan. 2011. With this concept, a weld seam is further provided between the drive housing and a connection piece of the reactor pressure vessel and has to be inspected regularly during operation of the power plant.

In the construction described in that instance, if a control rod is ejected the control rod with the control rod drive is caught in and by the drive housing. The drive housing is secured in the reactor pressure wall by at least one coupling element, and the force released when the control rod is ejected is transferred to the reactor pressure vessel and is dissipated. An advantage of this construction is that the holding function and the securing function are formed in a combined manner and therefore neither an external shielding plate nor additional components connecting the drive housing to the shielding plate are necessary for the securing function. On the other hand, the reactor pressure wall has to be particularly stable, since high impact forces may be transferred directly onto the pressure wall of the reactor. The stability of the pressure wall is reduced, in particular by the recesses in the pressure wall that are provided for connection to the coupling element of the drive housing, and therefore the pressure wall has to be particularly thick, at least reinforced locally.

### SUMMARY OF THE INVENTION

The object of the invention is to specify a device of the aforementioned type, with which an uncontrolled lowering of the respective control rod can be prevented as reliably as possible and which, at the same time, can be produced as cost effectively as possible and is maintenance-free during operation. In particular, the path over which the control rod can lower and possible leakage cross sections in the event of rupture or separation of housing components or other components are to be kept to a minimum.

The above object is achieved in accordance with the invention by the features of the claims.

Accordingly, a securing device for a control rod/control rod drive in a nuclear facility is proposed and has a control rod drive and a drive housing enclosing the control rod drive and configured to pass through a reactor pressure wall and through a reactor pressure wall connection piece arranged internally of the reactor pressure wall and connected to the reactor pressure wall. A number of releasable connection elements produced as separate components are provided between the reactor pressure wall connection piece and the drive housing. A respective connection element forms a form-locking connection to the drive housing and a form-locking connection to the reactor pressure wall in the final assembled position.

The substantially hollow cylindrical drive housing will also be referred to hereinafter as a drive housing tube.

The invention is based on the consideration of securing the drive housing of the control rod drive to the reactor pressure wall such that external components, in particular tie rods and shielding plates, are not necessary, but at the same time of not reducing the stability of the reactor pressure wall in the region of the drive housing as a result of excessively large recesses in the pressure wall. For this purpose, the combined holding and securing function is transferred to the reactor pressure wall connection piece, which continues the reactor pressure wall into the inner region of the reactor and surrounds the drive housing concentrically. Impact forces acting on the reactor pressure wall connection piece are transferred directly onto the reactor pressure wall. The connection of the reactor pressure wall connection piece to the drive housing is formed with a positive fit by the connection element or by the connection elements.

The respective connection element preferably forms a form-locking and/or force-locking, load-bearing/load-absorbing connection between the drive housing and the reactor pressure wall connection piece. Impact forces acting on the drive housing of the control rod drive, of which the vector component parallel to the longitudinal axis of the control rod and of the drive housing forms the predominant portion, are thus transferred from the drive housing to the reactor pressure wall connection piece by the, or each, connection element. Forces effective over the drive housing as a result of the shaping of the, or each, connection element, the forces acting substantially parallel to the longitudinal axis of the drive housing and of the control rod drive arranged therein, are preferably deflected and diverted in different directions, thus producing a buffer effect.

It is expedient if the, or each, connection element is configured in the form of a separated insert ring, in particular in the form of a ring separated into two and composed of two half rings. Such a construction is characterized by a particularly high level of compactness and stability, as well as by easy installation.

The insert ring further preferably has a tapering or expanding outer cross section and/or a tapering or expanding inner cross section. Forces acting on the insert ring via the drive housing parallel to the longitudinal axis of the drive housing and of the control rod drive arranged therein can thus be deflected, in part, into radial holding forces. A further advantage of the use of a separated, preferably wedge-shaped, insert ring is that excessive lowering or even ejection of the control rod is reliably prevented, even in the event of elongate ruptures of the drive housing tube, as will be explained in greater detail further below.

Additionally or alternatively, the insert ring is more preferably provided with wedge-shaped and/or nozzle-shaped holding elements in partial regions over the outer face and/or over the inner face. The reaction forces in the event of failure of the drive housing tube can be reduced considerably by holding elements of this type. Corresponding negative recesses or grooves are provided for the holding elements in the inner face of the reactor pressure wall connection piece so that the insert ring is held in a stable manner when the separated insert ring is in the fastened state.

In a particularly preferred embodiment of the securing device, a further annular end connection element in the form of a securing connection piece is provided in the region above the, or each, connection element, is arranged between the reactor pressure wall connection piece and the drive housing, and overlaps the drive housing at the end face. Such an end connection element supplements the connection element preferably formed as a separated insert ring. A particularly effective stabilization of the overall arrangement is achieved, in particular as a result of the overlap of the drive housing at the end face and as a result of a stable connection between the end connection element and the inner face of the reactor pressure wall connection piece.

A screw connection is preferably provided for the connection between the end connection element and the inner face of the reactor pressure wall connection piece. Such a screw connection is characterized by a particularly high level of stability as well as by the property of deflecting axially acting forces into radial force components and thus distributing them outwardly in a uniform manner. In addition, screw connections are an industry standard and are therefore available cost effectively over a wide range of different size variants. Where screw connections can be used (characteristically for connection and adapter elements in cylindrical geometries), they are a suitable replacement for fixed connections, which are typically formed by welded connections.

In the published, non-prosecuted German patent application DE 10 2011 008 202.6 A1, the upper end-face connection between the reactor pressure wall connection piece and the drive housing is formed with the aid of a weld seam. Since specific safety and inspection guidelines apply for weld seams in safety-critical areas (in particular in a nuclear facility), recurrent inspections using an ultrasonic inspection device, which has to be passed over the weld seam to be inspected, are necessary for monitoring of the weld seam. A welded connection of this type can be substituted by the connection element formed as a separated insert ring and by the end connection element provided with a screw connection. Ultrasonic inspection is therefore no longer necessary, and an at least constant or improved stability of the overall arrangement is provided at the same time. In addition, the connection is reversible, which is not the case with a weld seam and is advantageous for assembly operations in particular. Since the space for receiving an ultrasonic inspection device is no longer required, geometric constraints provided previously are no longer present and innovative constructional concepts can be used freely, in particular for the inner connection between the drive housing and control rod drive (see below).

In an expedient embodiment of the securing device, the control rod drive has a plurality of inner coupling elements for forming a form-locking and/or force-locking connection between the control rod drive and the drive housing. With a plurality of coupling elements, coupling elements are preferably arranged at different, defined altitudes with respect to the longitudinal axis of the control rod drive and of the drive housing.

An inner coupling element or a plurality of inner coupling elements is/are expediently configured in the form of a bayonet connection. Such a bayonet connection is suitable in particular for a stable concentric connection of two components, of which the shaping with regard to a characteristic longitudinal axis corresponds substantially to the geometry of two hollow cylinders arranged concentrically with respect to one another. The operating principle of the bayonet connection is known in principle from the above-mentioned prior application and does not need to be described again here.

At least one inner coupling element is advantageously arranged above the, or each, connection element with respect to the longitudinal axis of the control rod drive and of the drive housing. In practice, all relevant rupture locations of the drive housing tube are covered. Specifically, if the upper inner coupling element were arranged beneath the connection element preferably configured as a separated insert ring, a considerable lowering of the control rod in the event of rupture of the drive housing tube between the connection element and the upper inner coupling element therefore could not be ruled out reliably in all circumstances. By contrast, as a result of the described construction, the path over which the control rod lowers is limited to a few millimeters, even in the case of unfavorable rupture locations. The leakage cross sections becoming free in such an event are thus also minimized, and a relevant discharge of coolant from the reactor pressure vessel is prevented.

An inner coupling element or a plurality of inner coupling elements is/are provided with or connected to deforming elements, which are configured for absorption of impact forces as a result of plastic deformation. Some of the energy released in the event of control rod ejection can thus be absorbed and is no longer available during the subsequent transfer via the connection element, which is preferably configured as a separated insert ring. Due to a suitable shaping and material selection for the deforming elements and due to an increase in the overall number of the inner coupling elements provided with deforming elements of this type, the redundancy and therefore also the reliability of the securing device are increased.

The advantages achieved with the invention lie in particular in the fact that the upper inner bayonet connection between the drive housing and the control rod drive can be arranged geometrically higher than before due to the replacement of the previously provided weld seam between the reactor pressure wall connection piece and the drive housing with a screw connection, since the spatial requirement for the ultrasonic inspection device for inspecting the weld seam is no longer applicable. It is thus possible to relocate the coupling and holding function, which was previously implemented by an outer bayonet connection, into the region of the reactor pressure wall connection piece and to replace it with a separated insert ring arranged in this region. This also leads to the now described advantages.

A reduction in the inspection effort in the nuclear power plant as a result of the elimination of the recurrent ultrasonic inspection of the weld seam between the reactor pressure vessel connection piece and the drive housing.

An avoidance of an enlargement of the thickness of the reactor pressure vessel floor as a result of the elimination of the outer bayonet connection.

A simplified manufacture in the region of the reactor pressure vessel floor as a result of the elimination of the outer bayonet connection.

A simplified assembly as a result of the elimination of the rotation of the drive housing to decouple or couple the outer bayonet connection.

Security against envisaged elongate rupture locations of the drive housing as a result of the conical form of the insert ring.

Other features which are considered as characteristic for the invention are set forth in the appended claims.

Although the invention is illustrated and described herein as embodied in a securing device for a control rod in a nuclear facility, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a longitudinal sectional view of a securing device for a control rod in a nuclear facility according to the invention; and

FIG. 2 is an illustration of the securing device according to FIG. 1 in a reactor of the nuclear facility.

### DETAILED DESCRIPTION OF THE INVENTION

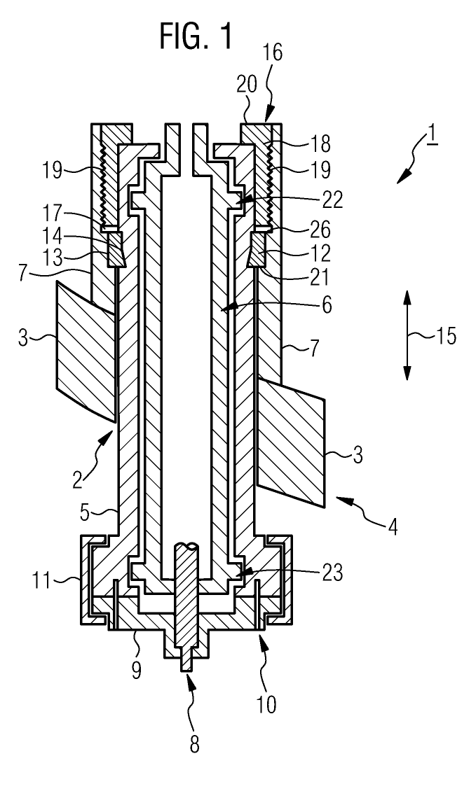

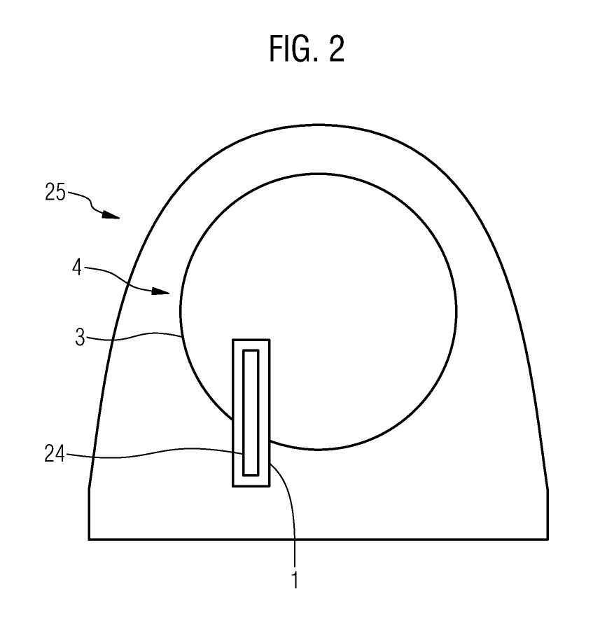

Corresponding parts are provided with identical reference signs in FIG. 1 and FIG. 2.

FIG. 1 shows a schematic longitudinal sectional illustration of a securing device 1 for a non-illustrated control rod in a nuclear facility. The securing device 1 contains a drive housing 5 of a control rod drive 6, the drive housing 5 being guided through a recess 2 in a reactor pressure vessel wall, or reactor pressure wall 3 for short, of a reactor pressure vessel 4 and being of substantially cylindrical configuration. The drive housing 5 is surrounded concentrically with little play by a reactor pressure wall connection piece 7 in the inner region of the reactor pressure vessel 4. The reactor pressure wall connection piece 7 is connected fixedly, in particular welded, to the reactor pressure wall 3. The control rod drive 6 arranged inside the drive housing 5 contains a motor-driven rotary shaft 8, which is mounted rotatably in a socket 9. The socket 9 is connected fixedly to the drive housing 5 by screws 10 and vice-grip wrenches 11.

To connect the drive housing 5 to the reactor pressure wall connection piece 7 and to safeguard against envisaged rupture locations (including ruptures on the longitudinal side) of the drive housing 5, a separated insert ring 12 is provided. In a final assembled position, the insert ring 12 engages with a positive fit and substantially with no play in corresponding annular grooves 13 and 14 in both the drive housing 5 and the reactor pressure wall connection piece 7. An impact caused by failure/rupture of the pressurized encapsulation is transferred via the insert ring 12 to the reactor pressure wall connection piece 7, and from here to the reactor pressure wall 3.

Due to the specific shaping of the insert ring 12, a reaction force of this type, which acts along a longitudinal direction 15 of the drive housing 5 and of the control rod drive 6, can be deflected in part into radial forces, and a buffer effect can be provided. The component of the force acting along the longitudinal direction 15 can thus be reduced. For this purpose, the insert ring 12 has a wedge-shaped cross-sectional contour in the lower portion in the exemplary embodiment with an inner radius that increases continuously from top to bottom. The respective groove 14 in the outer face of the drive housing 5 has a complementary accurately fitting cross-sectional contour. By contrast, the outer radius of the insert ring 12 and the inner radius of the corresponding groove 13 in the inner face of the reactor pressure wall connection piece 7 are constant over the entire height of the insert ring 12.

In the upper end-face region of the reactor pressure wall connection piece 7, the drive housing 5 is secured in the final assembled position by a securing connection piece 16 that is effective in the manner of a clamping nut. To this end, the securing connection piece 16 has an annular body 18 engaging in an annular gap 17 between the drive housing 5 and the upper portion of the reactor pressure wall connection piece 7, wherein a screw connection is formed between the annular body 18 and the reactor pressure wall connection piece 7 via corresponding threaded flanks 19. At the upper end, the securing connection piece 16 has an annular flange 20, which overlaps the drive housing 5 radially inwardly and suppresses the drive housing 5.

For assembly purposes, the insert ring 12 is separated, that is to say it contains at least two separate annular segments, preferably two half rings, which together form a complete ring when placed next to one another. The annular segments are inserted into the outer annular groove 14 in the drive housing 5 when the drive housing 5 is slid upwardly and the securing connection piece 16 is not yet provided. The drive housing 5 is then lowered downwardly into the final assembled position, so that the part of the separated insert ring 12 protruding radially outwardly from the drive housing 5 abuts the respective lower contact face 21 of the groove 13 in the reactor pressure wall connection piece 7 and a further lowering of the drive housing 5 is prevented. During the assembly process, the securing connection piece 16 is then screwed into the gap 17 from above so that the upward movement of the drive housing 5 is blocked by the annular flange 20.

So as to provide the necessary gap for the annular body 18 of the securing connection piece 16 and so as also to be able to lower the drive housing 5 with the inserted insert ring 12 without difficulty into the final assembled position from above, the wall thickness of the reactor pressure wall connection piece 7 is reduced in the upper portion. The wall of the reactor pressure wall connection piece 7 therefore has a setback with a horizontal shoulder 26 at the upper end of the upwardly open groove 13.

The control rod drive 6 is connected to the drive housing 5 by an upper inner coupling element 22 and by a lower inner coupling element 23, each configured in the form of a bayonet connection, wherein the coupling elements 22 and 23 each protrude radially outwardly from the cylindrical main body of the control rod drive 6 and engage in a corresponding recess in the inner face of the drive housing 5. To release the coupling, the upper inner coupling element 22 and the lower inner coupling element 23 can preferably be transferred from the coupling position into an open position and into the coupling position from an open position by a common coupling procedure. The coupling procedure is normally preferably carried out by a translation-rotation movement,

The upper inner coupling element 22 is arranged above the separated insert ring 12, as viewed in the longitudinal direction. As already described above, in the event of a rupture or break to the drive housing 5 below the insert ring 12, the possible path over which the control rod lowers is thus limited to a few millimeters and the possible leakage cross section is thus kept small.

FIG. 2 shows a schematically sketched illustration of a securing device according to FIG. 1 with a control rod 24 in a reactor pressure vessel 4 of a nuclear facility 25 of the boiling water reactor type.

In the application the term form-locking or positive connection is used. A form-locking connection is one that connects two elements together due to the shape of the elements themselves (i.e. ball and socket), as opposed to a force-locking connection, which locks the elements together by force external to the elements (i.e. a screw).

### LIST OF REFERENCE SIGNS

1 securing device
2 recess
3 reactor pressure wall
4 reactor pressure vessel
5 drive housing
6 control rod drive
7 reactor pressure wall connection piece
8 rotary shaft
9 socket
10 screw
11 vice-grip wrench
12 insert ring
13 groove
14 groove
15 longitudinal direction
16 securing connection piece
17 gap
18 annular body
19 threaded flank
20 annular flange
21 contact face
22 upper inner coupling element
23 lower inner coupling element
24 control rod
25 nuclear facility
26 shoulder

1. A securing device for a control rod in a nuclear facility, the securing device comprising:
a control rod drive;
a drive housing enclosing said control rod drive and configured to pass through a reactor pressure wall;
a reactor pressure wall connection piece disposed inwardly of the reactor pressure wall and connected to the reactor pressure wall; and
a number of releasable connection elements produced as separate components disposed between said reactor pressure wall connection piece and said drive housing, a respective connection element forming a form-locking connection to said drive housing and a form-locking connection to said reactor pressure wall connection piece in a final assembled position.

2. The securing device according to claim 1, wherein said respective connection element forms a load-absorbing connection between said drive housing and said reactor pressure wall connection piece.

3. The securing device according to claim 1, wherein said respective connection element is a separated insert ring.

4. The securing device according to claim 3, wherein said separated insert ring has an outer cross section one of tapering or expanding in an axial direction.

5. The securing device according to claim 3, wherein said separated insert ring has at least one of wedge-shaped holding elements or nozzle-shaped holding elements in partial regions over at least one of an outer face or over an inner face.

6. The securing device according to claim 1, further comprising a securing connection piece in a region above said respective connection element, said securing connection piece disposed between said reactor pressure wall connection piece and said drive housing, and overlaps said drive housing at an end face.

7. The securing device according to claim 6, further comprising a screw connection for a connection between said securing connection piece and an inner face of said reactor pressure wall connection piece.

8. The securing device according to claim 1, wherein said control rod drive has a plurality of inner coupling elements for forming at least one of a force-locking connection or a form-locking connection between said control rod drive and said drive housing.

9. The securing device according to claim 8, wherein at least one of said inner coupling elements is a component of a bayonet connection.

10. The securing device according to claim 8, wherein at least one of said inner coupling elements is disposed above said respective connection element, as viewed in a longitudinal direction of said control rod drive and of said drive housing.

11. The securing device according to claim 8, wherein at least one of said inner coupling elements has deforming elements, which are configured for absorption of impact forces as a result of plastic deformation.

12. The securing device according to claim 8, further comprising deforming elements, at least one of said inner coupling elements is connected to said deforming elements, which are configured for absorption of impact forces as a result of plastic deformation.

13. The securing device according to claim 3, wherein said separated insert ring has an inner cross section one of tapering or expanding in an axial direction.
